(19) United States
(12) Patent Application Publication
(10) Pub. No.: US 2013/0144738 A1
(43) Pub. Date: Jun. 6, 2013

(54) Gifting and Sharing Using SMS Messages for Shared Coupon/Gift-Card Auto-Redemption and Multi-Source Payment from Buyer's Mobile Phone

(71) Applicant: SPENZI, INC., San Jose, CA (US)

(72) Inventors: Bahman Qawami, San Jose, CA (US); Branimir Z. Talaich, Saratoga, CA (US); Matthew J. Farrell, San Jose, CA (US)

(73) Assignee: SPENZI, INC., San Jose, CA (US)

(21) Appl. No.: 13/677,267

(22) Filed: Nov. 14, 2012

Related U.S. Application Data
(60) Provisional application No. 61/565,988, filed on Dec. 2, 2011.
(60) Provisional application No. 61/565,979, filed on Dec. 1, 2011.
(60) Provisional application No. 61/586,765, filed on Jan. 14, 2012.
(60) Provisional application No. 61/594,699, filed on Feb. 3, 2012.

(51) Int. Cl. G06Q 20/40; H04W 4/14; G06Q 20/20

(52) U.S. Cl. CPC G06Q 20/40; G06Q 20/20; H04W 4/14
USPC 705/21

(57) ABSTRACT

A giving customer sends to a Short Message Service (SMS) gifting system a SMS text message with a gift amount, mobile phone number, and personal message for a receiving customer. The SMS gifting system authorizes payment for gifts by sending a SMS text message or secure hypertext transfer protocol (HTTPS) request to the giving customer's mobile phone or mobile device requiring customer to respond by SMS or HTTPS. When the giving customer replies to the SMS message with an approval code such as a Personal-Identification-Number (PIN), the SMS gifting system uses a queue of payment sources for the giving customer to create transaction requests to a bank authorization network. When the SMS gifting system receives authorization, it completes the gift transaction by sending a SMS message to the receiving user's mobile phone. Deals and vouchers may be shared among sub-users in a grouped account.

### RELATED APPLICATIONS

This application claims the benefit of the U.S. provisional applications for “Enabling user transaction to request, order, post transaction using mobile phone and/or online”, U.S. Provisional Ser. No. 61/565,988, filed Dec. 2, 2011, and “Shopping with Spenzi”, U.S. Provisional Ser. No. 61/586,765, filed Jan. 14, 2012, and “Enabling users to access process order post and login via a transactional based system”, U.S. Provisional Ser. No. 61/565,979, filed Dec. 1, 2011, and “Spenzi SaaS Payment Gateway Host For Mobile Payment”, U.S. Provisional Ser. No. 61/594,699, filed Feb. 3, 2012. This application is also related to the co-pending application for “Enabling a Merchant's Storefront POS (Point of Sale) System to Accept a Payment Transaction Verified by SMS Messaging with Buyer's Mobile Phone”, U.S. Ser. No. 13/466,435, filed May 8, 2012.

### FIELD OF THE INVENTION

This invention relates to mobile gifting systems, and more particularly to using standard mobile phones to enable gifting and related actions.

### BACKGROUND OF THE INVENTION

Mobile payments typically use mobile phones and credit or debit cards to allow users to pay for purchases. Many different mobile payment schemes have been proposed, and several are being tested. Success of these schemes has been limited for various reasons.

Some mobile payment systems may support one brand of smartphones but not other brands. Since the smartphone market is currently split, mobile payment systems that support only Android or only Apple phones eliminate half or more of the potential cell-phone users.

While smartphones have received a great deal of attention, many users still have older cell phones that do not run Android, Apple, or Windows software. The high cost of smartphones limits their acceptance in cost-sensitive foreign markets and among cost-sensitive customers.

The fragmented mobile phone market limits the success of mobile payment systems that function with only a particular kind of smartphone, or that do not work with older legacy cell phones. The inventors believe that the widespread acceptance of a mobile payment system depends on it being able to operate with all kinds of mobile phones, including smart phones of all types, and legacy cell phones.

In the related U.S. application Ser. No. 13/466,435 for “Enabling a Merchant's Storefront POS (Point of Sale) System to Accept a Payment Transaction Verified by SMS Messaging with Buyer's Mobile Phone”, filed May 8, 2012, Applicant describes how Short Message Service (SMS) text messages can be used with a modified merchant Point-Of-Sale (POS) system to verify and approve a payment using a traditional payment method, such as a credit card. The credit card information may be stored remotely, allowing the user to make payment to the merchant without showing the credit card to the merchant. Approval by the user is obtained using SMS text messages. A novel SMS payment system communicates with the user/customer through SMS text messages to verify the payment to the merchant.

While such a SMS payment system is useful, Applicant's desire to also use SMS text messages to send gifts or money from one user to another user, even when the receiver is not a user of the SMS payment system or an owner of a smartphone.

What is desired is a SMS gifting system that uses SMS text messages to send gifts to non-users. A SMS gifting system that does not require the use of smartphones is desirable. It is further desired to use and prioritize gift cards and other payment sources when making purchases. Account grouping to provide shared use of gift cards and deals is also desirable.

### BRIEF DESCRIPTION OF THE DRAWINGS

FIG. 1 shows a mobile gifting system using SMS text messaging.

FIG. 2 is a transaction diagram showing steps in processing a mobile gift using SMS verification.

FIGS. 3A-D show SMS text messages and replies when processing a mobile gift by SMS text messages.

FIG. 4 is a block diagram of an SMS mobile gifting system.

FIG. 5 is a diagram of a SMS gifting system host.

FIG. 6 shows a customer configuring gift card options.

FIG. 7 highlights multiple payment sources including gift cards for SMS mobile payments.

FIG. 8 highlights account grouping to share gifts, deals, or promotions using a SMS gifting system.

FIG. 9 shows deal sharing among two customers of the SMS gifting system.

FIG. 10 a diagram focusing on deal sharing within a SMS gifting system host.

FIG. 11 highlights short-code ordering using SMS text messaging with a SMS gifting system.

FIG. 12 highlights SMS text messages for deal sharing via forwarding using the SMS gifting system.

### DETAILED DESCRIPTION

The present invention relates to an improvement in SMS gifting and related operations. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

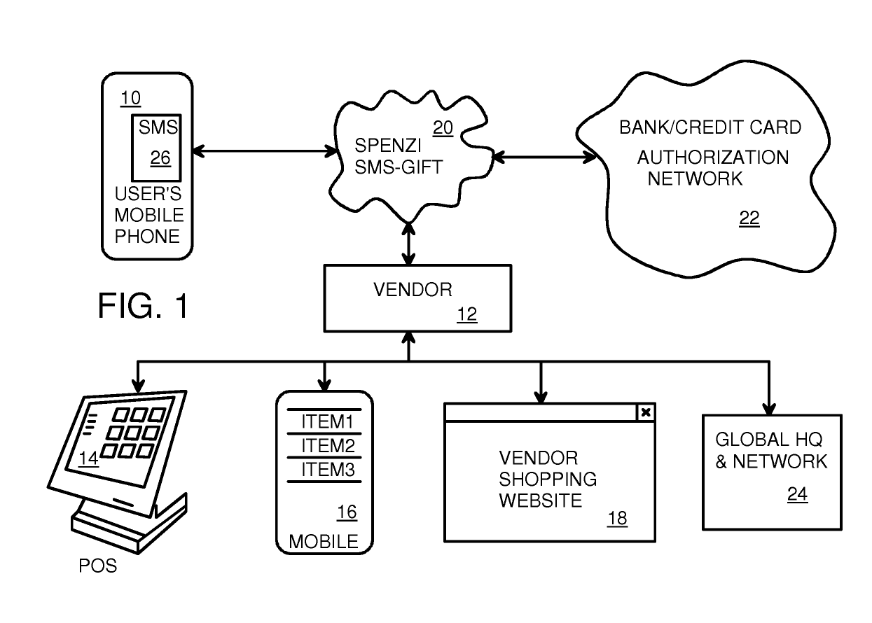

FIG. 1 shows a mobile gifting system using SMS text messaging. Vendor 12 has several payment systems, such as Point-Of-Sale (POS) terminals 14 in physical stores, mobile applications 16 that execute on customers' smartphones, vendor's shopping website 18 that customers can browse to, and vendor network 24 which includes other systems such as at a global headquarters, which may include a phone center that receives orders from customers. These act as POS endpoints.

SMS gifting system 20 is a cloud-based service that sends and receives SMS text messages to user's mobile device 10, which includes SMS module 26 for receiving and sending SMS text messages over a cellular or other network.

SMS gifting system 20 can process mobile payments and perform gifting that allows other users to make mobile payments. SMS gifting system 20 receives a request from vendor 12 when the customer carrying mobile device 10 initiates a purchase, such as at a checkout stand having a store clerk operating POS terminal 14. SMS gifting system 20 sends a SMS message to mobile device 10, and the customer responds to with another SMS text message back to SMS gifting system 20 to verify the purchase. Then SMS gifting system 20 uses stored gift card or other payment information for this user to authorize payment to vendor 12 using bank authorization network 22. The stored gift card may have earlier been paid for by another user and sent as a gift to the current user making the purchase.

SMS gifting system 20 can operate with many different vendors, and with many different banks and credit card processors. Vendor 12 does not have to handle SMS messages with mobile devices, since these details are handled by SMS gifting system 20. Gift cards may be issued by SMS gifting system 20, or maybe issued by bank authorization network 22.

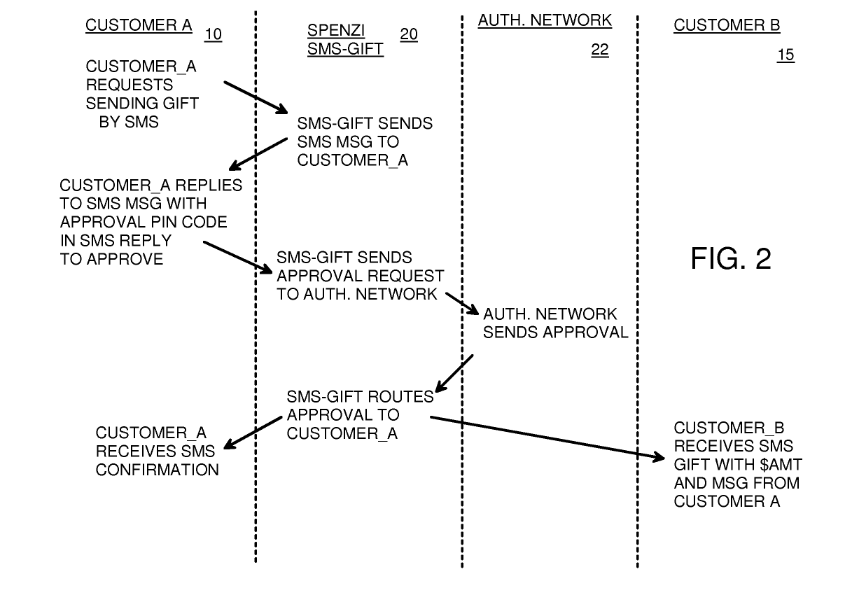

FIG. 2 is a transaction diagram showing steps in processing a mobile gift using SMS verification. The giving customer A carries mobile device 10, such as a smartphone of any kind, or a legacy cell phone that supports SMS text messaging. Giving customer A creates a request to send a gift to receiving customer B. This gift request may be a text message composed on mobile device 10, or may be created at the web site for SMS gifting system 20, or may be created by calling a phone center for SMS gifting system 20.

SMS gifting system 20 receivers the gift request and sends a SMS text message to mobile device 10 to confirm the gift. Giving customer A replies to the SMS text message with his approval Personal-Identification-Number (PIN) code and the reply SMS text message is routed from mobile device 10 back to SMS gifting system 20.

Giving customer A may pay for the cost of the gift using a credit or debit card. SMS gifting system 20 sends a payment approval request for the cost of the gift to bank authorization network 22. Once payment is authorized, bank authorization network 22 sends an approval message back to SMS gifting system 20.

SMS gifting system 20 then generates a confirmation SMS text message that is sent to mobile device 10 of giving customer A. This confirmation message informs customer A that the requested gift is being sent to customer B.

SMS gifting system 20 also generates a gift SMS text message that is sent to mobile device 15 of receiving customer B. This gift SMS text message informs customer B about the dollar amount of the gift, and may include a message from giving customer A. A link or phone number to call for more information on how to use the gift may be included in the gift SMS text message, especially if customer B has never used SMS gifting system 20.

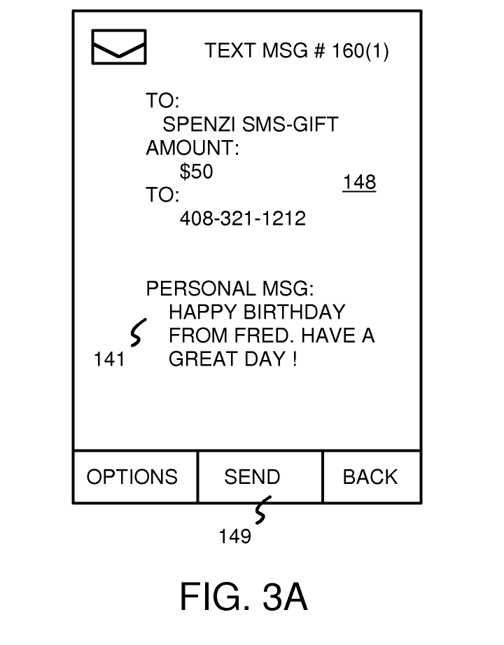

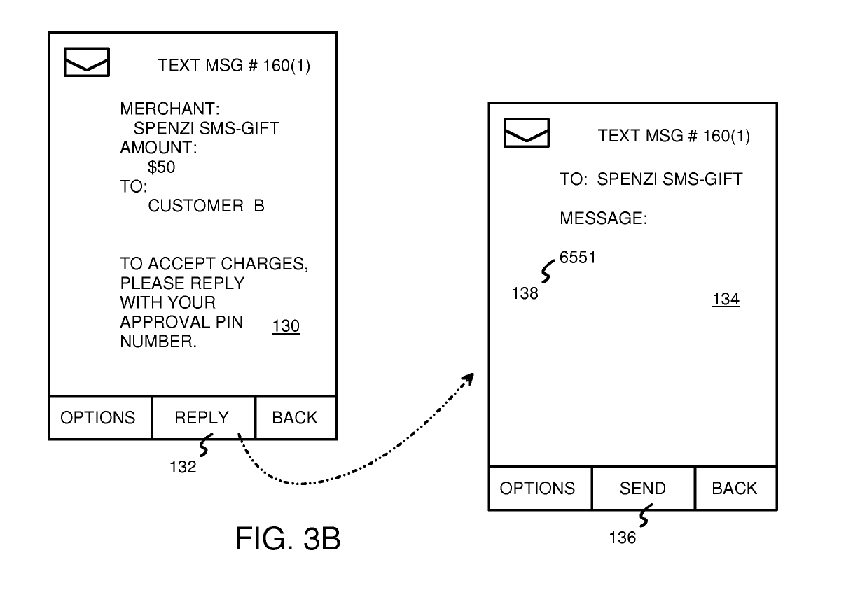

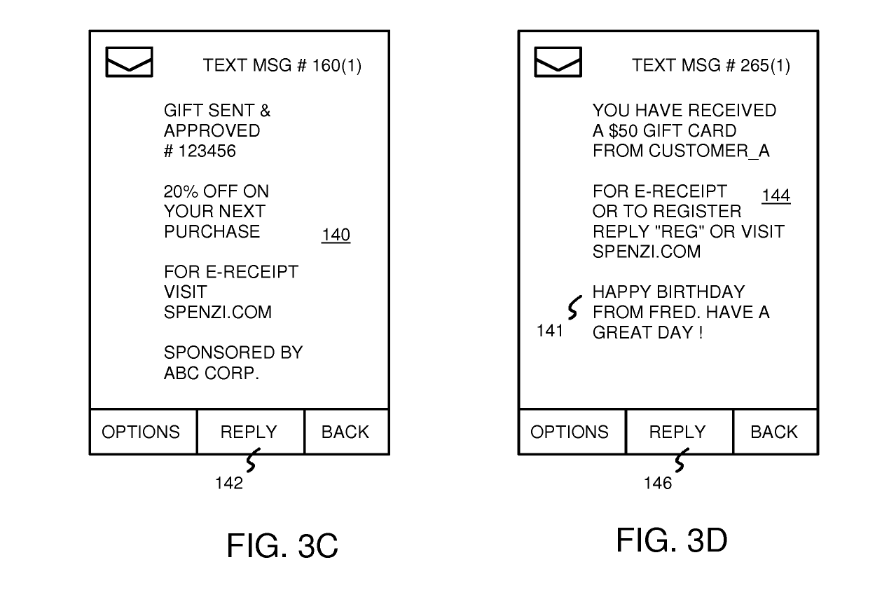

FIGS. 3A-D show SMS text messages and replies when processing a mobile gift by SMS text messages. In FIG. 3A, giving customer A uses a test messaging application executing on his mobile device 10 to create gift-request text message 148.

Gift-request text message 148 is addressed to SMS gifting system 20. A phone number for SMS gifting system 20 may be used, and this phone number may be stored in the contacts on mobile device 10 and an alias used (such as “Spenzi”) that is later converted to a phone number.

Gift-request text message 148 also contains the keyword “AMOUNT” and a dollar amount for the gift, and the keyword “TO” and the mobile phone number of receiving customer B. Other keywords and variations may be used.

Giving customer B also includes personal message 141. SMS gifting system 20 can interpret any text after the receiving customer's phone number as personal message 141. The length of personal message 141 may be limited by the length limit of SMS text message, such as 256 characters overall.

Once giving customer A has completed composing gift-request text message 148, customer A taps send button 149, which may be a mechanical button on mobile device 10 or may be an on-screen area of a touch screen.

In FIG. 3B, SMS text message 130 is sent from SMS gifting system 20 to giving customer A's mobile device 10 and displayed on the phone's display to customer A.

The text message shows SMS gifting system 20 “Spenzi SMS-GIFT” as the merchant, the amount of the gift, and the name of receiving customer B. The phone number of receiving customer B may be displayed, and if the name of customer B is obtained, it may also be displayed. The name may be obtained by a reverse directory lookup, by caller ID, or from the user database of SMS gifting system 20 if receiving customer B is already a registered user.

SMS text message 130 also contains a message to reply with the approval PIN to accept the gift charge. The giving customer A then presses reply button 132 on mobile device 10 and types in approval PIN 138. Customer A's approval PIN 138 is entered as “6551” by customer A typing in these 4 digits using a key pad on mobile device 10. The key pad may be an alphanumeric keyboard that is displayed on the display screen of mobile device 10, or may be physical telephone number keys on mobile device 10. Then the giving customer A presses send button 136 to send reply SMS text message 134 back to SMS gifting system 20.

In FIG. 3C, the approval PIN from customer A is matched to the customer's record by SMS gifting system 20 for approval, and then one or more transaction packets are sent to the bank authorization network to obtain an approval code. SMS gifting system 20 sends another SMS text message to customer A's mobile device 10. Approved message 140 indicates that the gift was approved and sent to customer B. Other information may be included in approved message 140, such as the approval code, an advertisement, or a discount code or other information for a future sale. Reply button 142 may be used in some embodiments for the customer to obtain the future discount, or to get more information.

In FIG. 3D, SMS gifting system 20 sends gift SMS text message 144 to mobile device 15 of receiving customer B. Gift SMS text message 144 informs customer B of the dollar amount of the gift, and may include personal message 141 from giving customer A.

A web link for SMS gifting system 20, or a phone number to call for more information on how to use the gift may be included in the gift SMS text message, especially if customer B has never used SMS gifting system 20. Alternately, gift SMS text message 144 may instruct customer B to reply to gift SMS text message 144 to obtain more information in a separate text message. Customer B may obtain this additional text message by tapping reply button 146 on his mobile device 15.

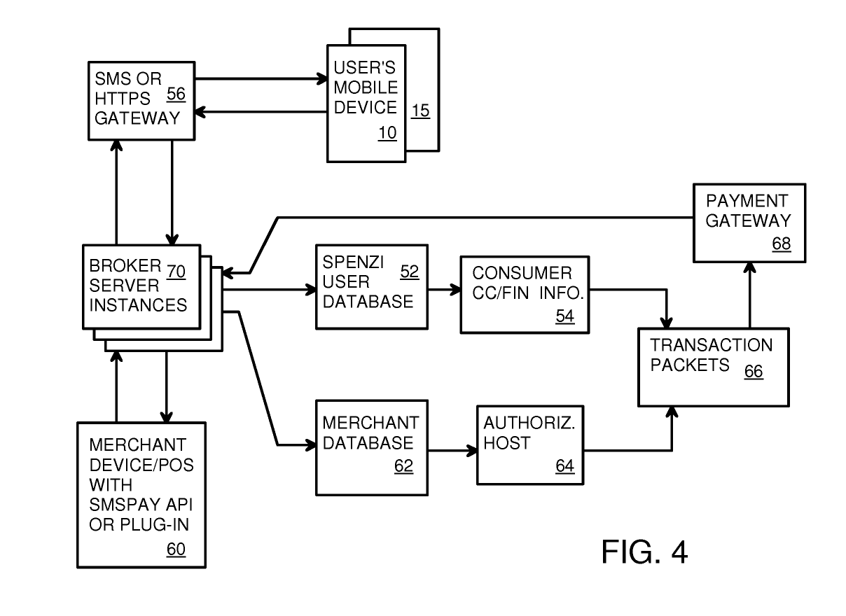

FIG. 4 is a block diagram of an SMS mobile gifting system. A customer carrying mobile device 10, such as a mobile phone, has previously registered to use SMS gifting system 20. The customer's data is stored in SMS gifting (Spenzi) user database 52, and includes an approval PIN that the customer selects. Other information may be included, such as the customer's zip code, or another PIN, such as the POS PIN, that the user pre-selects. The customer also enters payment information, such as for one or more credit cards, debit cards, gift cards, etc., which are stored in customer financial information database 54. The customer can enter payment, PIN, and other information at a web site for the SMS gifting system, or using a mobile app that links to that website.

In some embodiments, a SMS payment (SMSpay) plugin application or other code is installed on merchant POS terminals or merchant POS devices 60. The software on merchant POS devices 60 may be modified using instructions or commands that use an applications-programming interface (API) that connects to broker server instances 70 at SMS gifting system 20, rather than installing a plugin app.

Broker server instances 70 are created on the servers at SMS gifting system 20 to process gift requests from user and payment requests from merchants. Broker server instances 70 parse the incoming gift requests such as gift-request text message 148 (FIG. 3A) generated by customer A on mobile device 10 that are sent through SMS gateway 56. These gift requests are parsed for the giving customer's mobile phone number, which is looked up in SMS gifting user database 52. Broker server instances 70 also extract the receiving customer's phone number, the amount, and personal message 141 from gift SMS text message 144.

Broker server instances 70 then create SMS text message 130 (FIG. 3B) that is sent to mobile device 10 after being formatted as an SMS message by SMS gateway 56. The reply SMS text message or HTTPS connection messages are received from mobile device 10 by SMS gateway 56 and passed on to the requesting one of broker server instances 70. The reply text message contains the approval PIN that the customer entered on mobile device 10. Broker server instances 70 match that approval PIN from mobile device 10 with a stored approval PIN in SMS gifting user database 52 that the customer previously selected and stored.

Broker server instances 70 create transaction packets 66 once the customer's approval PIN is matched. The customer's payment information from customer financial information database 54 is combined with the merchant's information from merchant database 62 to form transaction packets 66 for purchases, or for SMS gifting system 20 acting as the merchant for gifts. The merchant's information may include pre-configured settings for a payment gateway that are provided by authorization host 64, which may be a third-party payment processor, bank, or other financial or merchant institution.

Broker server instances 70 may use the merchant's identifier from the request from merchant POS devices 60 to lookup merchant information in merchant database 62, and this merchant information is then sent to authorization host 64 and the reply data from authorization host 64 then merged into transaction packets 66 that are sent on to payment gateway 68.

Transaction packets 66, which consist of detailed financial information such as cardholder data and authentication data, stored in database 54, are sent to payment gateway 68. Payment gateway 68 processes the payment requests and responds with authorization codes and indicates that the transaction is completed, or with an error code.

Broker server instances 70 receive the authorization code from payment gateway 68 for the request, and send an approval message to merchant POS devices 60 and to mobile device 10 through SMS gateway 56. For gifts, broker server instances 70 generate approved message 140 to customer A and gift SMS text message 144 to customer B, which are both formatted as SMS text messages by SMS gateway 56 before being sent to the customers' mobile devices 10, 15. The gift card amount is added to the account for customer B in SMS gifting user database 52 or in consumer financial information database 54.

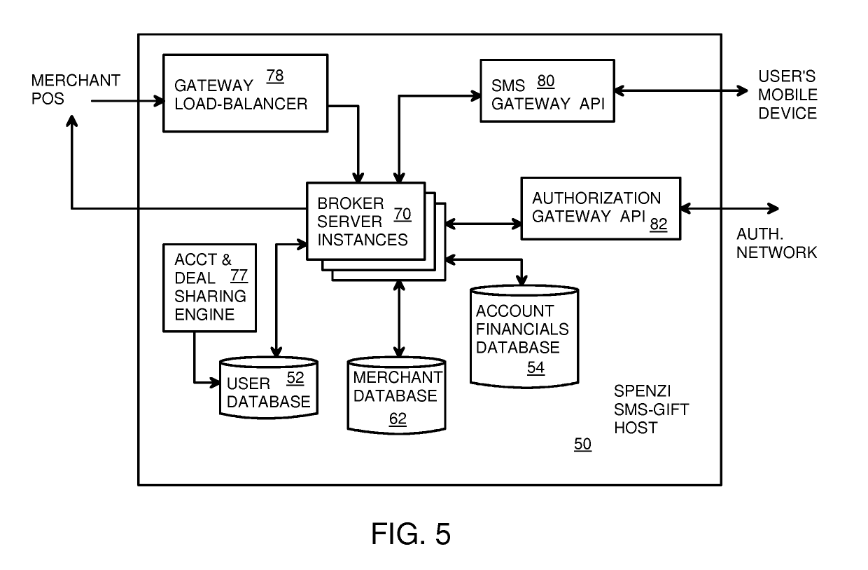

FIG. 5 is a diagram of a SMS gifting system host. SMS gifting host 50 has SMS gifting user database 52 that is populated with user records when a customer registers at a web site and enters his mobile phone number, mailing addresses, zip code (or POS PIN), and approval PIN. Merchant database 62 is populated by merchant records for merchants that have installed SMS payment plugin apps or other code to accept payment through SMS gifting host 50. Customer financial information database 54 contains the detailed financial information obtained when customers register, such as the credit card numbers, expiration dates, billing addresses, and verification codes. Additional levels of security such as encryption may be used to store data in customer financial information database 54 than with SMS gifting user database 52.

Incoming requests from merchant POS terminals and other merchant devices are load-balanced by gateway load-balancer 78 and assigned to instances in broker server instances 70 for processing. Text messages to customer mobile phones and other mobile devices that are generated by broker server instances 70 are formatted as SMS messages using SMS gateway API 80. HTTPS connections may be used in place of SMS and issued and then received by broker server instances 70. SMS reply messages and gift request messages from customer mobile devices are returned using SMS gateway API 80 to broker server instances 70.

Payment request packets to the authorization networks or gateways are created by instructions executed by broker server instances 70 that use authorization gateway API 82. Different merchants may require that broker server instances 70 send requests to different authorization networks or payment processors who use different API's.

Account grouping and deal sharing engine 77 allows multiple user accounts in SMS gifting user database 52 to be grouped together so those grouped accounts may share gift cards, deals, promotions, or other features of SMS gifting system 20. In some embodiments, gifts, credits, or deals may be transferred directly from one customer's account to another customer's account without activating bank authorization network 22 or authorization gateway API 82. Account grouping and deal sharing engine 77 may directly transfer gifts, credits, deals, or other promotions, or allow these to be shared among multiple customer accounts.

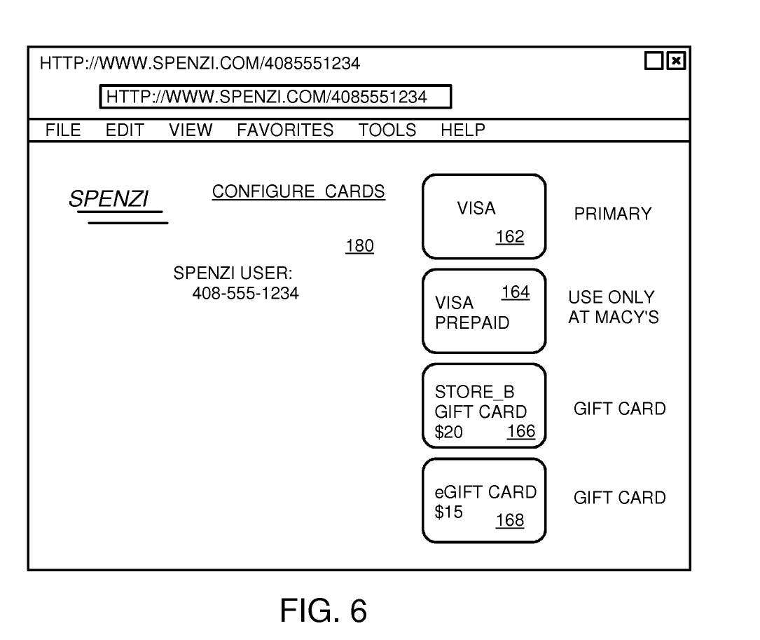

FIG. 6 shows a customer configuring gift card options. The customer may press a menu or other button (not shown) on a home account screen for the web site of SMS gifting system 20 to display configure card screen 180. The customer has set Visa credit card 162 as the primary payment source that is selected automatically at most merchants. Prepaid card 164 is configured to be used at one particular merchant instead of Visa credit card 162. Gift card 166 is used as a gift card for purchases at store B. Gift card 166 is used first, before Visa credit card 162 is charged for any remaining balance once gift card 166 is depleted.

Gift card 168 is another gift card that may be used at any online merchant. When a purchase is made at store B's website, store B gift card 166 is charged first, then any remaining balance is charged to girt card 168, and finally if the purchase exceeds the combined balances of both gift cards 166, 168, Visa credit card 162 is charged for the remainder. Additional credit, debt, and gift cards may be configured and rules set for prioritizing payment sources. Additional screens or pop-ups may be displayed to the customer to enter configuration information, rules, or to make selections.

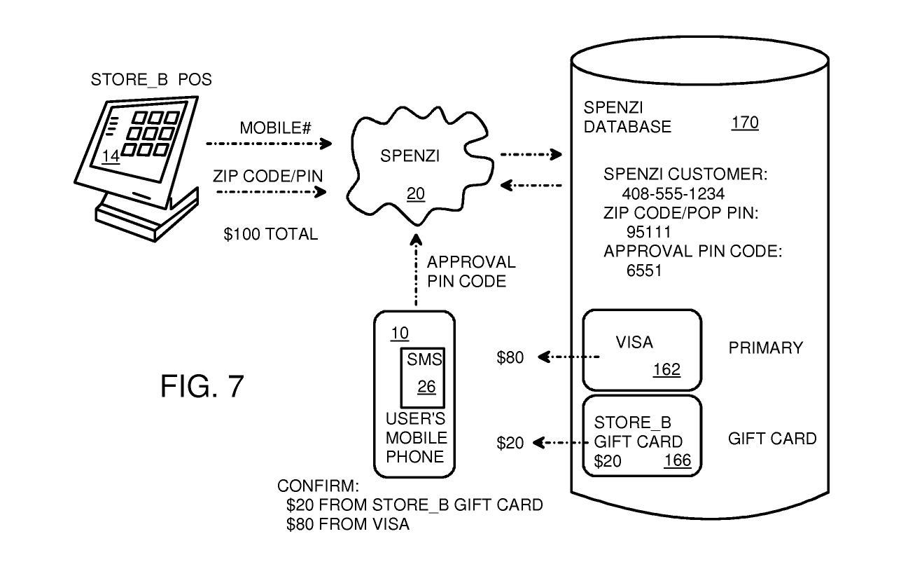

FIG. 7 highlights multiple payment sources including gift cards for SMS mobile payments. When a customer makes a purchase at a merchant's store, the store clerk operating POS terminal 14 activates a SMS payment plug-in application. A similar application is activated for an online purchase.

The customer must supply his mobile phone number and zip code (or POS PIN) at the point of purchase, and enter this information into POS terminal 14 to begin the transaction. SMS gifting system 20 then sends an SMS message to that mobile phone number. Most mobile devices have a unique identifier such as an International Mobile Equipment Identity (IMEI) number, which is a 15-digit serial number, and/or an International Mobile Subscriber Identity (IMSI), which is a 64-bit field store on the Subscriber Identity Module (SIM) card inside the mobile device. Mobile device 10 must use these unique identifiers to make a call over a cellular network. An encryption key may be used that is related to these unique identifiers. When a mobile phone is lost or stolen, these numbers may be placed on a black list to prevent their use. Thus mobile device 10 contains security features that are intended to quickly deactivate stolen phones.

SMS gifting system 20 may be configured to only send SMS text messages to valid phone numbers. SMS module 26 is an SMS application that sends SMS text messages over the cellular network, and excludes third party software such as text-messaging applications that execute on smartphones and PC's. These third-party applications are excluded since they allow the user to create an email address to receive text messages, and these email addresses are not necessarily the customer's mobile phone number. Thus SMS module 26 uses the customer's mobile phone number to receive SMS messages. Some smartphones may allow text messaging or other messaging by several methods, such as over a WiFi/cellular data network (such as Google Voice). These programs may include SMS module 26 that sends standard SMS text messages over the cellular network as a sub-set of their features. SMS gifting system 20 only communicates using standard SMS text messaging, or using a secure HTTPS connection that can be validated with the customer's mobile phone number, such as an HTTPS connection that can only operate on mobile device 10, not on PC's or other devices.

SMS gifting system 20 sends text messages to mobile device 10 when mobile device 10 has not been deactivated or blacklisted by the cellular carrier. SMS gifting system 20 inherently verifies the customer's mobile phone number since only that unique mobile device 10 can receive those SMS text messages, or receive an HTTPS connection from SMS gifting system 20. The reply SMS text message with the approval PIN must have been sent from mobile device 10, operating with an IMSI, IMEI, or other device identifiers.

SMS gifting system 20 selects the payment sources based on rules the customer specifies, such as when configuring from the web site, as show in FIG. 6. When the merchant operating POS terminal 14 is store B, Gift card 166 is selected as the first source of funds. If the purchase amount exceeds the value of gift card 166, then the remaining funds are charged to Visa credit card 162. The amounts charged to gift card 166 and to Visa credit card 162 are shown to the customer in a SMS text message sent to mobile device 10, such as the SMS text message asking for the approval PIN.

The approval PIN received from mobile device 10 must match the stored approval PIN for that customer's record in SMS gifting database 170. The customer's mobile phone number is used to lookup the record in database 170, while the zip code from POS terminal 14 and the approval PIN from mobile device 10 must match the stored values in database 170.

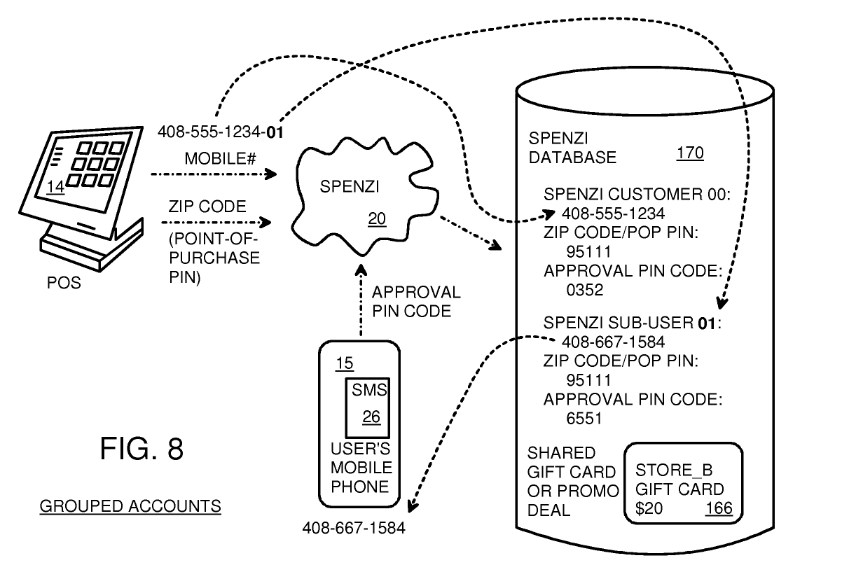

FIG. 8 highlights account grouping to share gifts, deals, or promotions using a SMS gifting system. Customers' accounts are identified by a mobile phone number in SMS gifting database 170. A family or other group may have several members, each with his own mobile device 10, 15. While each family member could have his own account for using SMS gifting system 20, a grouped account may be used to facilitate sharing.

In this embodiment of account grouping, a primary customer's phone number identifies the grouped account. A two-digit sub-user code is appended to this customer's mobile phone number to identify sub-users in the grouped account.

In the example of FIG. 8, the primary customer has a phone number of 408-555-1234 and is referred to as sub-user -00. A second customer in the grouped account is user -01, and has a different mobile phone number of 408-667-1584 for his mobile device 15. Each sub-user has a two-digit sub-user code and their own PIN codes and mobile phone numbers.

When sub-user -01 makes a purchase at store B, and the store clerk operating POS terminal 14 asks for his mobile phone number, sub-user -01 does not enter his actual phone number. Instead, the primary customer's phone number is entered, along with the sub-user's code of -01: 408-555-1234-01. SMS gifting system 20 looks up this phone number to locate the grouped account in SMS gifting database 170, and then finds sub-user -01 in that record. The mobile phone number stored for sub-user -01 is read from SMS gifting database 170, and the SMS text message is sent to this mobile phone, not to the primary mobile phone. Thus SMS gifting system 20 sends a SMS text message to sub-user -01's mobile device at 408-667-1584, not to the primary phone 408-555-1234.

Sub-user -01 replies to the SMS text message with his approval PIN, which is then matched to the stored approval PIN for sub-user -01 in SMS gifting database 170.

Gift card 166 may be shared among all sub-users in the grouped account. Thus the current purchase is charged first to gift card 166 when making a purchase at store B, regardless of which sub-user is making the purchase. A different sub-user may have received gift card 166 than the sub-user who uses gift card 166. Gift card 166 may thus be shared among several sub-users in a grouped account.

Rather than gift card 166, other payment sources such as credit or debit cards may be shared among some or all sub-users in a grouped account. The primary customer may specify which sub-users may access which payment sources or gift cards. Alternately, a sub-user who receivers a gift card may indicate which other sub-users may use the gift card as a payment source.

While gift card 166 has been shown, other payment sources may be shared in a similar fashion, such as credit cards, debit cards, store credits, deals, or promotions. For example, when one sub-user receives a deal in a text message, that user may allow all other sub-users in the grouped account to use that deal. Once the gift card, credit, deal, or promotion has been used by any of the grouped account's sub-users, the deal is deleted or marked as used so that it is used only once.

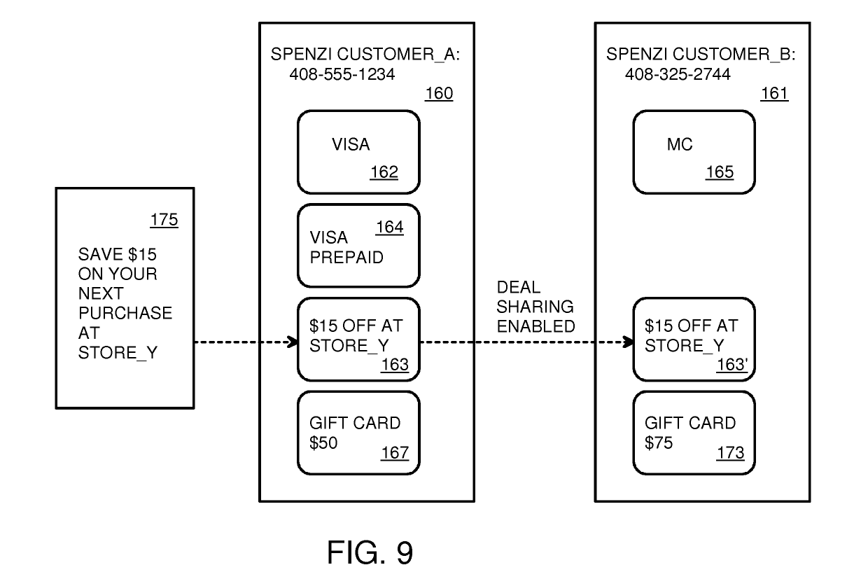

FIG. 9 shows deal sharing among two customers of the SMS gifting system. User A and user B have separate accounts that are not grouped together. Deal 175 is received by customer A. Deal 175 reduces a purchase at store Y by $15. Deal 175 is stored in SMS gifting database 170 in record 160 for customer A as one of the payment sources. Deal 175 becomes stored deal 163 in record 160. When customer A makes a purchase at store Y, deal 163 reduces the payment by $15, and the remainder is charged to another payment source, such as Visa credit card 162 or gift card 167.

Customer A can also specify that deal 175 be shared with customer B. Customer A could configure his account to share all deals with customer B, or customer A could specify that deal 175 be shared, such as by replying to deal 175 with the name of user B in a deal sharing filed.

Once shared, deal 175 becomes deal 163 in record 160 for customer A, and also becomes deal 163′ in record 161 for customer B. When customer B makes a purchase at store Y, deal 163′ reduces the payment by $15, and the remainder is charged to another payment source, such as MC credit card 165 or gift card 173. Once either customer A or customer B uses deal 163, 163′ for payment, deals 163, 163′ are deleted from both records 160, 161.

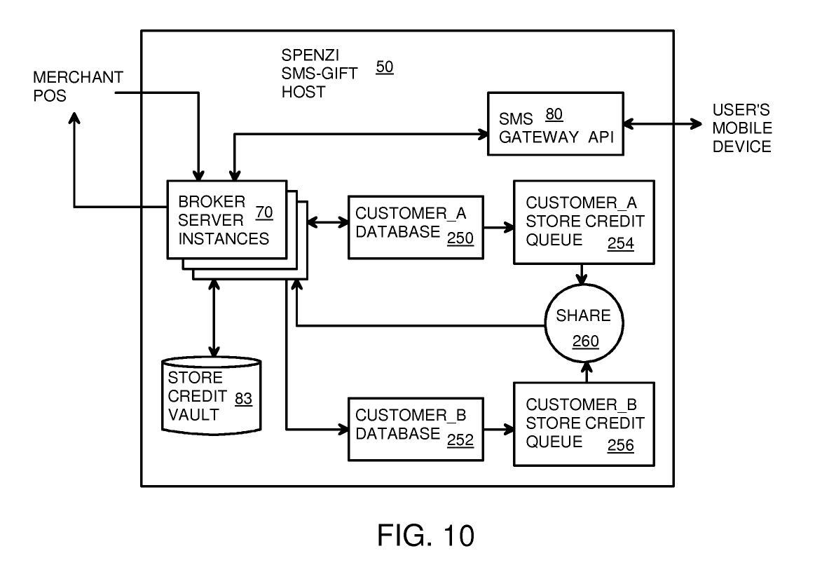

FIG. 10 a diagram focusing on deal sharing within a SMS gifting system host. SMS gifting host 50 may have other components (not shown) such as shown earlier in FIG. 5. Deals from merchants or from the SMS gifting system are sent to customers' mobile devices as SMS text messages through SMS gateway API 80. A customer may reply to the SMS text message to accept the deal, activating one of broker server instances 70 to store the deal with the customer's record in SMS gifting user database. The value of the deal and other deal details may be stored in store credit vault 83 and linked to one or more customer records. The deal may also be a store voucher, a gift card, or a store credit that the customer purchases or receives.

For example, customer A may reply to accept a deal sent by a SMS text message. Broker server instances 70 links the deal from store credit vault 83 to customer A database record 250 so that the deal is accessible to customer A in the future. The deal acts as a store voucher that can reduce the payment required for a future purchase. This store voucher is added to customer A's store credit queue for the particular store issuing the voucher. Customer A's store credit queue 254 contains the voucher and back-up credit or debit cards to be used at that store when a purchase is made.

Customer A may have deal sharing enabled with customer B. Customers A and B could both be in a grouped account, or could otherwise be configured to share deals and store vouchers. Broker server instances 70 also links the deal from store credit vault 83 to customer B database record 252 so that the deal is also available to customer B. The shared store voucher is also added to Customer B's store credit queue 256.

When customer A later makes a purchase at the issuing store, customer A's store credit queue 254 is accessed, causing the store voucher to be used up, and any remainder charged to the back-up credit or debit cards. Sharing engine 260 then activates one of broker server instances 70 to cancel the shared store voucher and break the links from store credit vault 83 to customer A database record 250 and to customer B database record 252.

Likewise, if customer B made a purchase at the issuing store, Customer B's store credit queue 256 is accessed, and sharing engine 260 cancels the shared store voucher for all linked accounts. Thus several customers may share access to the shared store voucher, although the store voucher can only be redeemed once by one of the customers.

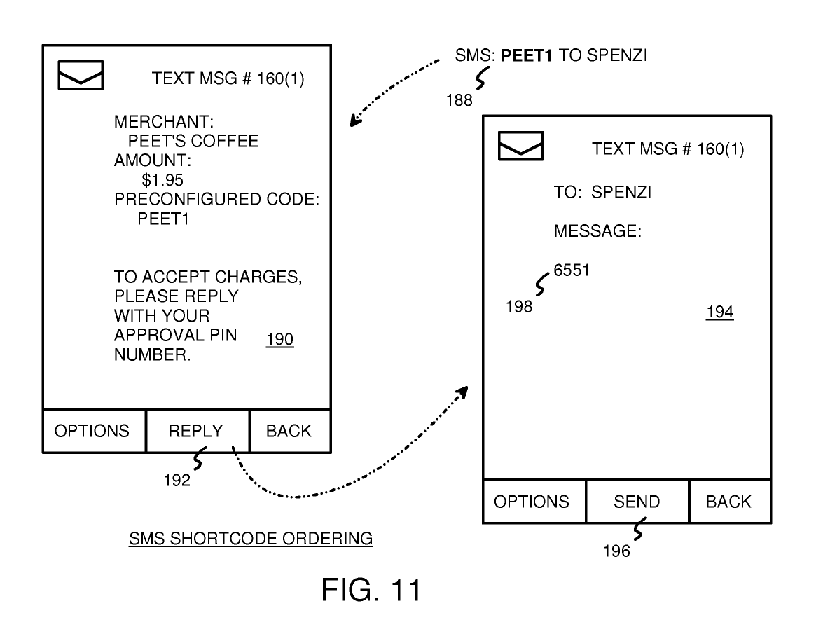

FIG. 11 highlights short-code ordering using SMS text messaging with a SMS gifting system. The customer may pre-configure a particular order with a particular merchant, such as by using the web site for the SMS gifting system. The pre-configured order may later be activated by sending a short-code as a SMS text message to the SMS gifting system. Short-code ordering is particularly useful for repeated purchases.

In this example, the customer has pre-configured an order for a large double-espresso coffee at a coffee shop that is located on his way to work. The pre-configured order is identified by the short-code “PEET1”, which the customer has chosen. The customer may navigate menus or enter a search for Peet's coffee on the SMS gifting system web site, and then use menus to select the particular coffee shop location and item for purchase.

In the morning before leaving for work, the customer sends SMS text message 188 to the SMS gifting system that contains the short-code “PEET1”. The SMS gifting system may have a short identifier such as 773694 for “Spenzi” rather than a full phone number. The short identifier may be recognized by the SMS infrastructure and directly routed without using the traditional telephone infrastructure.

The SMS gifting system looks up the customers mobile phone number in its SMS gifting user database, and locates the short-code “PEET1” that the customer has previously configured. The SMS gifting system then sends SMS text message 190 to the customer's mobile phone, indicating the merchant, amount, and a request to confirm using the customer's PIN.

The customer hits reply button 192, which creates reply message 194. The customer types in his PIN code 198 and hits send button 196. reply message 194 is sent to the SMS gifting system, which sends the pre-configured order to the pre-configured merchant. That merchant prepares the coffee, which is waiting for the customer when he arrives at the coffee shop. The customer's order may be identified at the coffee shop by the customer's mobile phone number or by the customer's name.

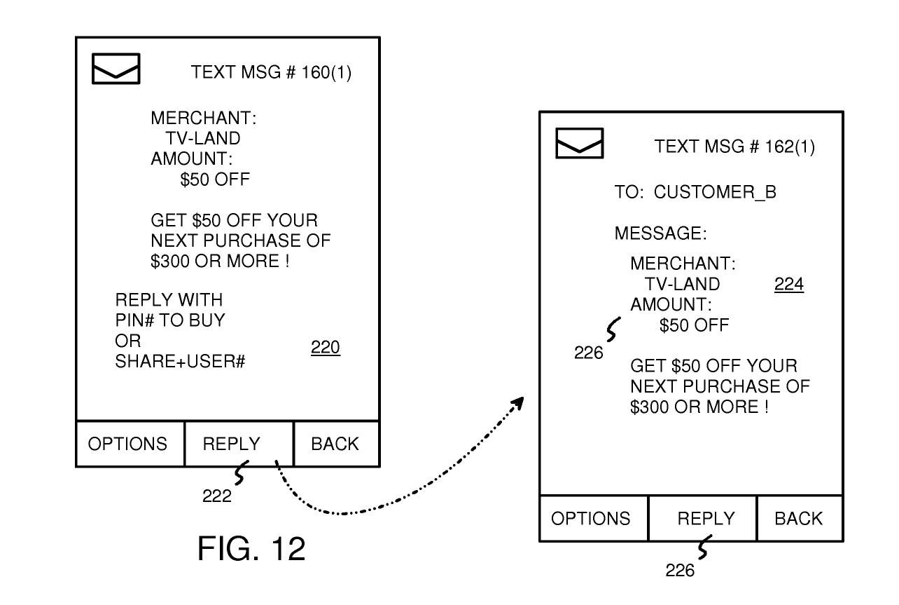

FIG. 12 highlights SMS text messages for deal sharing via forwarding using the SMS gifting system. A merchants sends advertisement SMS text message 220 to customer A's mobile phone. The deal is for $50 the next purchase of $300 or more at the merchant. This deal is linked to customer A's account, such as shown in FIG. 10, so that customer A can auto-redeem the deal in the future.

Customer A could immediately accept the deal and buy a particular item advertised (not shown) in advertisement SMS text message 220 by touching reply button 222 and replying with his PIN code. The deal would be redeemed and the remainder changed to customer A's back-up credit or debit cards, according to Customer A's store credit queue 254. This instant buying by SMS text messages may also allow the customer to specify a quantity or color, such as by exchanging additional text messages and replies.

Customer A could also forward the deal to customer B. Customer A hits reply button 222 on his mobile device, then types in the key word “SHARE” followed by the mobile phone number of customer B. After customer A sends the reply to the SMS gifting system, the SMS gifting system creates another advertisement SMS text message 224 that is sent to customer B's mobile device. Customer B could also immediately buy the advertised item by touching reply button 226 and entering his PIN code. if customer B is not a user of the SMS gifting system, hitting reply button 226 could have the SMS gifting system generating additional SMS text messages to customer B's mobile phone, allowing customer B to sent up an account with the SMS gifting system.

### Alternate Embodiments

Several other embodiments are contemplated by the inventors. For example, many variations of the SMS text messages are possible, and various combinations of messages and replies are possible. There may be several payment sources in Customer A's store credit queue 254 that are processed in a pre-defined order, such as using store vouchers, then gift cards specific to that merchant, then more general gift cards, then a debit or credit card.

Text messages to customer mobile phones and other mobile devices that are generated by broker server instances 70 are formatted as SMS messages using SMS gateway API 80. HTTPS connections may be used in place of SMS and issued and then received by broker server instances 70. SMS reply messages and gift request messages from customer mobile devices are returned using SMS gateway API 80 to broker server instances 70, or using HTTPS or other connections or protocols. Thus while SMS has been described, HPPTS or other mobile protocols and applications may be substituted. Multi-Media System (MMS) or other protocol messages with graphics, audio, or video may be substituted for SMS.

Store vouchers or credits may be purchased at a discount to face value. A third party such as an advertiser, a non-profit group such as a school booster club, consolidator, or other third party may also receive a credit when the store voucher is purchased or otherwise obtained. Non-profits can sponsor campaigns to get consumers to purchase store vouchers, with a portion of the store's proceeds going back to the non-profit. Other variations of giveback initiatives may be substituted.

The “gift” sent in FIGS. 2-3 may be a gift card that the giving customer purchases during the transactions shown, or a gift card that the giving customer already has purchased. The giving customer could be allowed to select from among stored gift cards in his account to give to the receiving customer. A list of existing gift cards could be sent as an additional SMS text message to allow the giving customer to chose from. The gift card could originally have been a give to the giving customer who then re-gifts the gift card to the receiving customer. The “gift” sent could also be a direct dollar credit for any merchant, or for a specific merchant or group of merchants. A store credit, voucher, or discount could also function as the “gift”.

Deal sharing could also operate on store vouchers, credits, gift cards, discounts, sales, or other promotions that function as “deals” that are shared among a group of customers in a grouped account, or customers that link to each other or otherwise offer to share their deals. A customer could also receive a hardcopy deal, such as on a flyer or cash register receipt, or could view a similar deal on a poster at the store, online, on TV, or by other advertising. A code printed on the displayed or hardcopy deal could be sent to the SMS gifting system, such as by a SMS text message, or by entering the hardcopy deal code on the web site for the SMS gifting system. The hardcopy deal code could be looked up by the broker server instances and a store credit or deal created for the customer. The created credit or deal could then be shared with other customers as described earlier, such as by being entered in Customer A's store credit queue 254 and Customer B's store credit queue 256. A third party service could also collect such deals and share them with customers.

When mobile device 10 is a smartphone configured properly, SMS gateway 56 may instead send the text message using a Secure Hyper-Text Transfer Protocol (HTTPS) connection that sends and receives Transport-Control-Protocol Internet Protocol (TCP/IP) packets with mobile device 10 over a cellular or other data network.

There may be two factors of authentification required, in addition to the customer's phone number. The correct zip code (or POS PIN) must be entered at POS terminal 14, and the correct approval PIN must be sent as a SMS text message from mobile device 10.

The primary customer on a grouped account could be notified by SMS text message when another sub-user makes a purchase. The grouped account could be configured so that purchases above a specified dollar amount much be approved by the primary customer while purchases below the specified dollar amount may be approved by a sub-user. Parents could allow some purchasing below a specified limit for children using this feature. The primary customer could approve the sub-user's purchase by replying with the primary customer's approval PIN. SMS gifting system 20 could require both the primary customer and the sub-user to reply to SMS messages before the purchase is approved.

Many variations of display screens of POS terminal 14 are possible, and for other displays and web pages and SMS messages shown in the drawings. While SMS gifting system 20 using SMS text messaging has been described, SMS gifting system 20 may use HTTPS or Hyper-Text-Markup-Language version 5 (HTML5) or later when connecting to some advanced smartphones or other mobile device 10. SMS gifting system 20 may have the ability to use SMS for older mobile phones, and more advanced and secure connections that feature handshaking and packet exchange with more advanced mobile devices. Encryption keys may also be exchanged in some of these advanced connection methods.

While POS terminal 14 has been described as being operated by a store clerk or employee, some POS terminals 14 may be self-server and operated by the customer. Other POS terminals 14 may have the customer enter information on a small keypad so that the store clerk does not see this information, such as a POS PIN. POS terminal 14 could also be located at a call center where the customer is not physically present, or be part of an online store, such as part of a checkout shopping program. POS terminals traditionally have a drawer for accepting cash, and are a replacement for a cash register.

POS terminal 14 could be on a mobile device such as a tablet, mobile phone, or other mobile device. POS terminal 14 could be a game console, a smart refrigerator or other smart appliance, a gasoline pump, a smart TV, a set-top box, a GPS device, a WiFi router, a tablet, a laptop, a camera, any video-based interface system, an audio system with some interface to purchase, any Internet device with a screen, or any connected device with a remote web interface/software interface. The generic term POS endpoint is intended to include POS terminals 14, whether traditional stationary cash registers, mobile tablets or other devices that a store clerk carries around a store, mobile applications that execute on customers' smartphones, vendor's shopping websites that customers can browse to, and the vendor network which includes other systems such as at a global headquarters, which may include a phone center that receives orders from customers.

While the customer either verbally telling the sales clerk or manually typing in the customer's mobile phone number and zip code or POS PIN has been described, voice recognition software could be used to capture the information. A random or other security question could be asked of the customer, either in place of the zip code or in addition to the zip code. Some embodiments may rely on only the mobile phone number, not a zip code or second piece of information from the customer. Some advanced smartphones may be detectable by POS terminal 14, such as over a wireless network, and this could be an additional factor for verification. The SMS gifting system could be used in combination with other security and payment systems.

If the zip code or POS PIN does not match, SMS gifting system 20 could initiate a voice call to mobile device 10 and have an operator or a computerized system ask the customer for additional or backup verification. This additional verification could also be sent by SMS text messaging, email, or other methods. These phone calls could be recorded.

If verification fails, the purchase is blocked. The customer could be notified by other means that does not rely on the physical possession of mobile device 10, such as email, a call to a home phone or to a friend's phone, and/or mail. A security group at SMS gifting system 20 or a bank or credit card company could also be notified, as could the cellular carrier. An SMS message indicating that the purchase has been declined may also be sent, either when the approval PIN is not matched, or bank authorization network 22 fails to authorize the charge, such as for insufficient credit or funds. Various steps may be repeated for a fixed number of times, such sending the SMS message again if the customer mistakenly types in the wrong approval PIN.

While the customer replying to the SMS text message with her approval PIN has been described, the customer could also be asked to answer a multiple-choice security question, enter some other piece of information, or even reply with a random code that is part of the SMS text message. For example the SMS text message could say “reply with code 5251”. The customer then replies with a text message saying “5251”.

SMS gifting system 20 has the merchant install a plugin application on POS terminal 14 or otherwise modify its software. However, the customer does not have to install any software on mobile device 10. The customer only has to link his mobile phone number to his payment method and provide verification information. The customer may do this by logging on to the web site for SMS gifting system 20, or its parent company, or a business partner's web site that provides this linking. The customer could call in to a call center to register and link his phone number and provide payment and verification information over the phone, or even in person at a store, such as at POS terminal 14. The customer could also use a smartphone application that uses HTTP5 or HTTPS to register for, configure, and monitor use of SMS payment.

Payment sources could include credit cards, debit cards, gift cards, checking accounts or other bank or brokerage accounts, various merchant programs such as reward points programs or loyalty programs, or any other money or quasi-money source. The user may define nicknames for payment sources and configure rules for selecting payment methods, such as to use a particular card at a particular merchant, default cards, backup cards, etc. The SMS payment configuration web site could provide a list of all merchants accepting SMS payments, allowing the customer to configure various cards or payment sources for various merchants. Some merchants may offer discounts or other incentives, or display advertising to the customer on the SMS payment web site. Various menus or dialog boxes may be used to assist the customer in configuring payment sources and rules.

Registered customers may suspend payments by SMS gifting system 20. The customer could telephone a call center for SMS gifting system 20 to request suspension of a particular transaction, or to suspend all transactions, such as if mobile device 10 is lost. The customer could also suspend transactions by logging on to the SMS gifting system website and selecting a suspend transaction feature. In some embodiments the customer may be able to suspend transactions at POS terminal 14 by telling the store clerk, who uses the SMS payment plugin application to suspend the customer's SMS pay account. The customer could also send a specific trigger code by SMS to SMS gifting system 20 that causes the account to be frozen immediately.

While SMS gifting system 20 creating transaction packets of a request to bank authorization network 22 have been described, SMS gifting system 20 could notify the merchant of authorization by SMS, send the customer's payment information, and then allow the merchant to directly process the transaction with bank authorization network 22. Several variations of authorization are possible. The merchant may handle authorization with the bank or financial network, and merely use the SMS gifting system to exchange SMS text messages with the customer for verification, with the customer still providing a copy of his credit card to the merchant. In this variation, the SMS gifting system is simply an additional verification method. Alternately, the SMS gifting system could send the customer's payment information to the merchant rather than to the authorization network, or could provide this information to a third party who then combines the customer's payment information with information from the merchant before sending the authorization request to the authorization network. The authorization network itself may be quite complex with several intermediate steps and processes.

A customer could be a retail shopper, and online shopper, a wholesale purchaser, a program or application user, or other purchaser of goods, services, or software. The customer's phone number and zip code or POS PIN could be encrypted for transmission from POS terminal 14 to SMS gifting system 20. Other messages could also be encrypted, partitioned, scrambled, or otherwise modified. SMS gifting system 20 could further verify that the SMS reply message is from the customer's mobile device 10 by matching the user's mobile phone number in the reply SMS message, or by matching text copied in the reply SMS message from the original SMS text message sent to the customer.

A single profile picture may be stored, or additional history of pictures may be stored. These additional pictures may be references with previous pictures for further security steps, such as to prevent a completely different person from using the account, since pictures of the original account owner are retained. Profile pictures may be linked to POS PIN(s) for multi-use cases such as allowing additional authorized users on the account, such as for Family, Corporate, or Group accounts.

The background of the invention section may contain background information about the problem or environment of the invention rather than describe prior art by others. Thus inclusion of material in the background section is not an admission of prior art by the Applicant.

Any methods or processes described herein are machine-implemented or computer-implemented and are intended to be performed by machine, computer, or other device and are not intended to be performed solely by humans without such machine assistance. Tangible results generated may include reports or other machine-generated displays on display devices such as computer monitors, projection devices, audio-generating devices, and related media devices, and may include hardcopy printouts that are also machine-generated. Computer control of other machines is another tangible result.

Any advantages and benefits described may not apply to all embodiments of the invention. When the word “means” is recited in a claim element, Applicant intends for the claim element to fall under 35 USC Sect. 112, paragraph 6. Often a label of one or more words precedes the word “means”. The word or words preceding the word “means” is a label intended to ease referencing of claim elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC Sect. 112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A computer-implemented method for sending a gift to a second mobile device in response to a gift-request mobile message from a first mobile device comprising:
receiving the gift-request mobile message from the first mobile device, the gift-request mobile message including a specification of a gift from a first customer to a second customer and a second mobile device number for the second mobile device;
using a first mobile device number of the first mobile device to find a first located user record for the first customer in a user database, the first mobile device number associated with the gift-request mobile message;
sending a first mobile message to the first mobile device, the first mobile message causing the specification of the gift to be displayed to the first customer on the first mobile device;
receiving a reply mobile message from the first mobile device, the reply mobile message including an approval code from the first customer;
matching the approval code from the reply mobile message to a stored approval code in the first located user record to indicate approval of the gift amount by the first customer;
sending a confirming mobile message to the first mobile device when the approval code is matched, the confirming mobile message including an indication of authorization of the gift; and
sending a gift-notifying mobile message to the second mobile device when the approval code is matched, the gift-notifying mobile message including the specification of the gift,
whereby the gift is sent from the first customer to the second customer using mobile messages.

2. The computer-implemented method of claim 1 wherein the specification of the gift in the gift-request further comprises a gift amount;
further comprising:
sending an authorization request to a financial authorization network, the authorization request including the gift amount and payment information for the first customer, wherein the payment information is obtained using a pointer in the first located user record; and
receiving an authorization code from the financial authorization network, and blocking sending of the gift-notifying mobile message when the authorization code indicates a denial,
whereby the approval code is obtained by mobile messages to the first mobile device of the first customer.

3. The computer-implemented method of claim 1 wherein the gift-request mobile message further comprises a personal message;
further comprising:
including the personal message from the first customer when creating the gift-notifying mobile message to the second mobile device;
wherein the personal message from the first customer is sent to the second customer with the gift-notifying message.

4. The computer-implemented method of claim 1 further comprising:
when the first mobile device is a legacy mobile phone that does not support advanced web browsing, sending the first mobile message comprises sending a Short Message Service (SMS) text message as the first mobile message and receiving the reply mobile message comprises receiving a SMS text message as the reply mobile message;
when the first mobile device is an advanced smartphone that has advanced web browsing enabled, sending the first mobile message comprises opening a connection to the first mobile device using a Secure Hyper-Text Transfer Protocol (HTTPS) connection or using Hyper-Text-Markup-Language version 5 or above (HTML5) to send the first mobile message;
when the second mobile device is a legacy mobile phone that does not support advanced web browsing, sending the gift-notifying mobile message comprises sending a Short Message Service (SMS) text message as the gift-notifying mobile message;
when the second mobile device is an advanced smartphone that has advanced web browsing enabled, sending the gift-notifying mobile message comprises opening a connection to the second mobile device using a Secure Hyper-Text Transfer Protocol (HTTPS) connection or using Hyper-Text-Markup-Language version 5 or above (HTML5) to send the gift-notifying mobile message;
whereby mobile messages are adaptive for legacy mobile phones and for advanced smartphones.

5. The computer-implemented method of claim 4 wherein sending the first mobile message comprises sending the first mobile message over a first cellular network operated by a first cellular phone provider using the first mobile device number to identify the first mobile device;
wherein sending the gift-notifying mobile message comprises sending the gift-notifying mobile message over a second cellular network operated by a second cellular phone provider using the second mobile device number to identify the second mobile device,
whereby mobile messages are sent over cellular networks.

6. The computer-implemented method of claim 1 further comprising:
using the second mobile device number of the second mobile device to find a second located user record for the second customer in the user database;
when the second located user record is not found in the user database, including a registration instruction in the gift-notifying mobile message, the registration instruction informing the second customer to register to create an account in the user database.

7. The computer-implemented method of claim 1 further comprising:
generating the specification of the gift by selecting a gift from a first queue of payment sources, the first queue of payment sources being associated with the first located user record in the user database;
wherein the first queue of payment sources include one or more of a credit card, a debit card, or a gift card;
whereby a gift card is able to be re-gifted from the first customer to the second customer.

8. A mobile sharing system comprising:
a user database having user records for customers, wherein a user record for a customer comprises a mobile device number that uniquely identifies the customer's mobile device, and a payment queue for locating payment information for the customer from a plurality of payment sources;
a mobile messaging gateway for sending a first mobile message to the customer's mobile device over a mobile network using the mobile device number that uniquely identifies the customer's mobile device, and for receiving a second mobile message from the customer's mobile device in response to the first mobile message;
an authorization gateway for sending an authorization request to a financial authorization network when the second mobile message is received and verified, the authorization request including an identifier of a merchant and payment information located for the customer using the payment queue, the authorization gateway receiving a completed message from the financial authorization network when payment is authorized;
a plurality of broker server instances, each broker server instance for processing a transaction by receiving a merchant request from the merchant, extracting an extracted mobile device number from the merchant request, using the mobile device number to locate a matching customer record in the user database, activating the mobile messaging gateway to send the first mobile message to the extracted mobile device number, verifying the second mobile message, activating the authorization gateway to send the authorization request, and activating the merchant gateway to send a complete transaction message to the merchant in response to the completed message;
a sharing engine, coupled to the user database, for sharing a shared payment source, the shared payment source being shared among multiple customers, wherein a plurality of mobile device numbers share the shared payment source,
whereby transactions are processed by verifying the second mobile message received from the customer's mobile device in reply to the first mobile message.

9. The mobile sharing system of claim 8 wherein the shared payment source is a credit card, a debit card, a gift card, a voucher for a merchant, a store credit for a merchant, a discount for a merchant, a deal, or a promotion for a merchant.

10. The mobile sharing system of claim 9 wherein the user database further comprises grouped accounts, wherein a grouped account comprises a primary mobile device number and a secondary mobile device number;
wherein the extracted mobile device number from the merchant request comprises the primary mobile device number and a sub-account identifier associated with the secondary mobile device number;
wherein the mobile messaging gateway sends the first mobile message to the secondary mobile device number and receives the second mobile message from the secondary mobile device number;
wherein the plurality of broker instances uses the shared payment source when activating the authorization gateway to send the authorization request,
whereby the shared payment source is used for a payment verified by the first mobile message to the secondary mobile device number in the grouped account.

11. The mobile sharing system of claim 9 wherein the user database further comprises:
a first payment queue having a first plurality of payment sources for a first customer record in the user database;
a second payment queue having a second plurality of payment sources for a second customer record in the user database; and
a shared payment source in both the first plurality of payment sources and in the second plurality of payment sources, the shared payment source being usable for at least a portion of a payment by either a first customer or by a second customer.

12. The mobile sharing system of claim 11 wherein the sharing engine further comprises an auto-redemption engine, the auto-redemption engine being activated when the shared payment source has a finite value that is less than or equal to a purchase amount of a transaction being processed by a broker server instance, the auto-redemption engine disabling the shared payment source in the first payment queue and in the second payment queue among the multiple customers when one of the multiple customers uses the shared payment source for a transaction,
whereby the shared payment source is auto-redeemed for the multiple customers.

13. The mobile sharing system of claim 12 wherein the payment information comprises a plurality of payment sources and a plurality of transaction amounts, each payment source generating an authorization request for a transaction amount through the authorization gateway, or generating a redemption a transaction amount from the payment source;
wherein the first mobile message includes a list of the plurality of payment sources and a list of the plurality of transaction amounts, wherein the customer using the customer's mobile device verifies the list of the plurality of payment sources and the list of the plurality of transaction amounts when sending the second mobile message to the mobile messaging gateway,
whereby the plurality of payment sources are verified by the second mobile message.

14. The mobile sharing system of claim 13 wherein the user record in the user database further comprises an approval Personal-Identification-Number (PIN) known by the customer;
wherein the second mobile message further comprises the approval PIN entered by the customer on the customer's mobile device;
further comprising:
an approval PIN verifier for matching the approval PIN from the second mobile message with the approval PIN stored in the user record in the user database,
whereby the customer approves the transaction by inserting the approval PIN into the second mobile message.

15. The mobile sharing system of claim 14 wherein the first mobile message comprises a Short Message Service (SMS) text message sent to customer's mobile device using the mobile device number read from the user record in the user database;
wherein the second mobile message comprises a SMS text message that the customer sends in reply to the first mobile message, wherein the second mobile message comprises the approval PIN entered by the customer on the customer's mobile device.

16. The mobile sharing system of claim 13 wherein the first mobile message and the second mobile message are sent over a secure hyper-text transfer protocol (HTTPS) connection or using a Hyper-Text-Markup-Language version 5 (HTML5) connection.

17. A mobile-payment sharing system comprising:
merchant payment means for calculating a payment amount and for receiving a mobile device number and a second value from a customer;
merchant request means for sending a merchant request to a mobile gifting system, the merchant request including the payment amount, the mobile device number, and the second value;
record lookup means for using the mobile device number extracted from the merchant request to locate a user record in a user database;
first verification means for comparing the second value extracted from the merchant request to a stored second value stored in the user record and for denying payment when a mismatch occurs;
mobile message means for sending a first mobile message to a mobile device identified by the mobile device number extracted from the merchant request, the first mobile message indicating the payment amount extracted from the merchant request;
mobile verification means for receiving a reply mobile message from the mobile device, the reply mobile message including an approval code from the customer in response to the first mobile message, and for denying payment when an approval code mismatch occurs;
authorization request means for generating an authorization request to a payment processing network, the authorization request including the payment amount, an identifier for a merchant, and payment source information for the customer;
store vault means for storing store credits for a merchant;
promotion means for sending a promotion mobile message to the mobile device and for receiving an acceptance reply from the mobile device;
deal generating means for generating a deal in response to the acceptance reply, the deal including a store credit from the store vault means, the store credit for reducing the payment amount,
whereby the deal is generated in response to the acceptance reply from the mobile device.

18. The mobile-payment sharing system of claim 17 further comprising:
deal sharing means for adding the deal to a first payment queue for a first customer, and to a second payment queue for a second customer, the first payment queue being for a first user record in the user database, the second payment queue being for a second user record in the user database,
whereby deals are shared among multiple customers.

19. The mobile-payment sharing system of claim 18 further comprising:
gifting means, activated by a gift-request mobile message from the first customer, for generating a gift to the second customer, wherein the gift is added to the second payment queue and removed from the first payment queue.

20. The mobile-payment sharing system of claim 17 further comprising:
legacy means, activated when the mobile device is a legacy mobile phone that does not support advanced web browsing, for sending the first mobile message using a Short Message Service (SMS) text message sent over a cellular network operated by a cellular phone provider, and for receiving a SMS text message as the reply mobile message;
advanced means, activated when the mobile device is an advanced mobile device, for sending the first mobile message by opening a connection to the mobile device using a Secure Hyper-Text Transfer Protocol (HTTPS) connection or using Hyper-Text-Markup-Language version 5 or above (HTML5) to send the first mobile message and to receive the reply mobile message,
whereby mobile messaging is adaptive for legacy mobile phones and for advanced mobile devices.
